(19) United States
(12) Patent Application Publication
(10) Pub. No.: US 2025/0164783 A1
(43) Pub. Date: May 22, 2025

(54) Driver Gaze Driven Head-Up Display Local Dimming

(71) Applicant: Panasonic Automotive Systems Company of America, Division of Panasonic Corporation of North America, PEACHTREE CITY, GA (US)

(72) Inventor: JOSEPH THOMAS PERRY, OXFORD, MI (US)

(21) Appl. No.: 18/951,883

(22) Filed: Nov. 19, 2024

Related U.S. Application Data
(60) Provisional application No. 63/601,804, filed on Nov. 22, 2023.

(51) Int. Cl. G02B 27/01; B60K 35/235; B60K 35/65

(52) U.S. Cl. CPC G02B 27/0101; B60K 35/235; B60K 35/654; G02B 27/0179; B60K 2360/21; B60K 2360/31; B60K 2360/349; G02B 2027/0118; G02B 2027/0187

(57) ABSTRACT

A head up display arrangement for a motor vehicle includes a driver-monitoring camera capturing images of a human driver of the motor vehicle. A picture generation unit emits a light field such that the light field is reflected by a windshield of the vehicle so as to be visible by a human driver of the motor vehicle as a virtual image. An electronic processor is communicatively coupled to the driver-monitoring camera and to the picture generation unit. The electronic processor receives the images captured by the driver-monitoring camera and determines, dependent upon the captured images, an element in the virtual image at which eyes of the human driver are looking. The electronic processor controls the picture generation unit to increase a relative brightness of the element in the virtual image at which eyes of the human driver are looking as compared to brightnesses of other elements in the virtual image.

### CROSS-REFERENCED TO RELATED APPLICATIONS

This application claims benefit of U.S. Provisional Application No. 63/601,804, filed on Nov. 22, 2023, the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

Automotive Head-Up Display (HUD) systems typically have a static brightness or are light-dependent but not driver gaze-dependent. Current HUDs can dim according to exterior conditions (time of day, weather, ambient light) but they perform the dimming across the entire content.

The other way that content is dimmed is through local dimming techniques, but again the dimming is not selective and all content remains in full brightness. Some HUDs perform local dimming, which increases contrast by dimming the background behind dim or dark areas of the virtual image, thereby increasing the contrast between those dark areas and bright elements that are in the virtual image.

HUDs take up a portion of the driver's forward view, potentially obscuring or being a distraction. As the size of virtual images produced by HUDs has been increasing over the years, the obscuring of the driver's forward view has become an even bigger issue. Another problem is that power consumption is also a concern as HUD sizes increase.

### SUMMARY

The present invention may provide a heads-up display (HUD) including graphics having variable brightness of HUD content. The brightness may be dependent upon whether the driver is looking directly at the content or not. The HUD content may become brighter as a result of the driver looking at the content directly as the focus of his gaze. Using local dimming and eye tracking, different content can become more prominent or fade out depending on need.

By highlighting the content that the driver appears to be trying to view, the cognitive load of the driver can be reduced, thereby improving HUD safety. Another advantage is that selective highlighting can provide power savings compared to typical local dimming systems.

The inventive system may be implemented through local dimming hardware, with LED (light emitting diode) cells being turned ON or OFF depending on the user's gaze direction. A group of cells depicting or being related to a given piece of content may be turned ON or OFF as a group. Alternatively, the brightness of the content may be controlled with a laser-based system, wherein the content brightness is dictated by the driver's gaze direction when the content is rendered.

In one embodiment, the invention comprises a head up display arrangement for a motor vehicle including a driver-monitoring camera capturing images of a human driver of the motor vehicle. A picture generation unit emits a light field. At least one mirror reflects the light field emitted by the picture generation unit such that the reflected light field is again reflected by a windshield of the motor vehicle so as to be visible by a human driver of the motor vehicle as a virtual image. An electronic processor is communicatively coupled to the driver-monitoring camera and to the picture generation unit. The electronic processor receives the images captured by the driver-monitoring camera and determines, dependent upon the captured images, an element in the virtual image at which eyes of the human driver are looking. The electronic processor controls the picture generation unit to increase a relative brightness of the element in the virtual image at which eyes of the human driver are looking as compared to brightnesses of other elements in the virtual image.

In another embodiment, the invention comprises a method of operating a head up display for a motor vehicle, including emitting a light field, and reflecting the emitted light field such that the reflected light field is again reflected by a windshield of the motor vehicle so as to be visible by a human driver of the motor vehicle as a virtual image. Images of a human driver of the motor vehicle are captured. An element in the virtual image at which eyes of the human driver are looking is determined dependent upon the captured images. The picture generation unit is controlled such that the element in the virtual image at which eyes of the human driver are looking becomes brighter than another element in the virtual image.

In yet another embodiment, the invention comprises a head up display arrangement for a motor vehicle, including a driver-monitoring camera capturing images of a human driver of the motor vehicle. A picture generation unit emits a light field. At least one mirror reflects the light field emitted by the picture generation unit such that the reflected light field is again reflected by a windshield of the motor vehicle so as to be visible by a human driver of the motor vehicle as a virtual image. An electronic processor is communicatively coupled to the driver-monitoring camera and to the picture generation unit. The electronic processor receives the images captured by the driver-monitoring camera, and determines, dependent upon the captured images, an element in the virtual image at which eyes of the human driver are looking. The electronic processor controls the picture generation unit to change a characteristic of the element in the virtual image at which eyes of the human driver are looking.

### BRIEF DESCRIPTION OF THE DRAWINGS

A better understanding of the present invention will be had upon reference to the following description in conjunction with the accompanying drawings.

FIG. 1 is a schematic diagram of one embodiment of a head up display arrangement of the present invention.

FIG. 2a is a plan view of an example virtual image that may be produced by the head up display arrangement of FIG. 1.

FIG. 2b is a plan view of another example virtual image that may be produced by the head up display arrangement of FIG. 1.

FIG. 2c is a plan view of yet another example virtual image that may be produced by the head up display arrangement of FIG. 1.

FIG. 3 is a flow chart of one embodiment of a method of the present invention for operating a head up display in a motor vehicle.

### DETAILED DESCRIPTION OF THE PREFERRED EMBODIMENTS

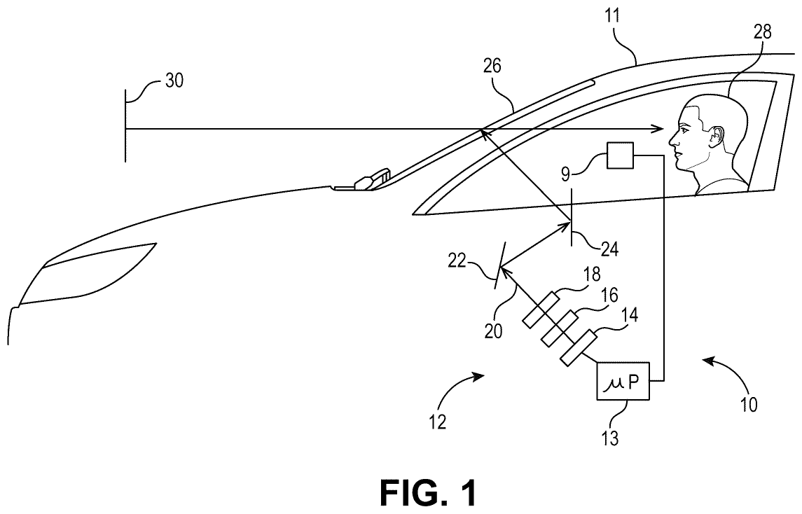

FIG. 1 illustrates one embodiment of a head up display arrangement 10 of the present invention installed in a motor vehicle 11. Arrangement 10 includes a driver-monitoring camera 9, an electronic processor 13 and a picture generation unit 12. Picture generation unit (PGU) 12 includes LEDs 14, optics (e.g., lenses) 16 and liquid crystal display (LCD) 18.

During use, driver-monitoring camera 9 captures images of the face of a human driver 28. Electronic processor 13 receives the images captured by camera 9 and analyzes the images to determine the direction in which the eyes of driver 28 are looking. A light field 20 (which is shown in FIG. 1 as a single ray for ease of illustration) from PGU 12 may be reflected by mirrors 22, 24 and windshield 26 such that light field 20 is visible to driver 28 as a virtual image 30.

Processor 13 may provide the content of light field 20 to PGU 12. Based on the direction in which processor 13 determines that driver 28 is looking, processor 13 may also ascertain what elements in virtual image 30 driver 28 is looking at. Processor 13 then may adjust light field 20 to make the elements at which driver 28 is looking brighter than the elements at which driver 28 is not looking.

Processor 13 may increase the relative brightness of the elements at which driver 28 is looking by performing local dimming. In order to increase the relative brightness, processor 13 may increase the brightness (i.e., absolute brightness) of the elements at which driver 28 is looking, and/or may decrease the brightness (i.e., absolute brightness) of the elements at which driver 28 is not looking.

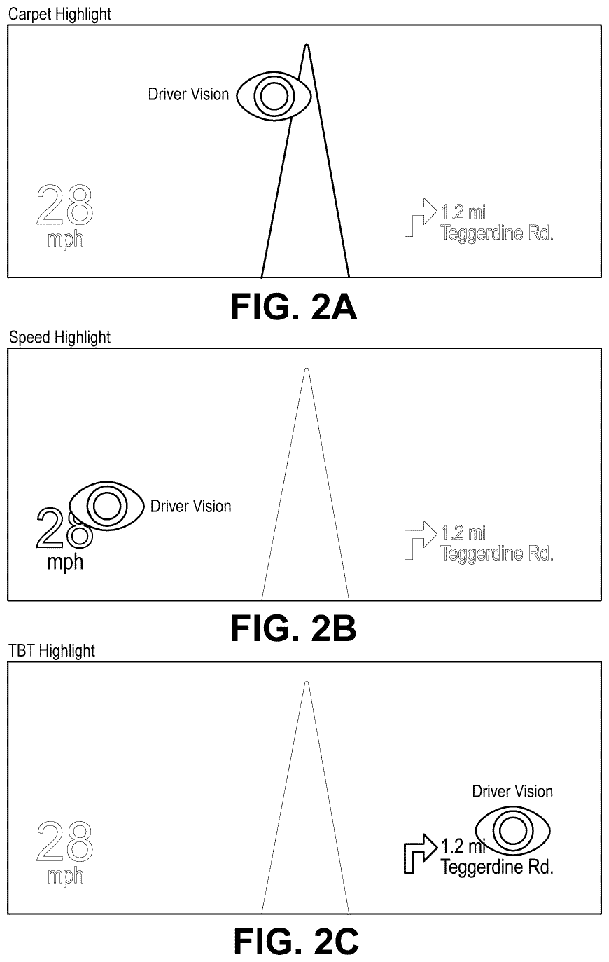

FIG. 2a illustrates an example virtual image that may be produced by head up display arrangement 10. In response to camera 9 and processor 13 determining that driver 28 is looking at a lane marking in the virtual image, processor 13 may cause the lane marking to be brighter in the virtual image than other elements in the virtual image, such as the vehicle speed indication and the turn-by-turn (TBT) navigation information, as shown in FIG. 2a.

FIG. 2b illustrates another example virtual image that may be produced by head up display arrangement 10. In response to camera 9 and processor 13 determining that driver 28 is looking at a vehicle speed indication in the virtual image, processor 13 may cause the vehicle speed indication to be brighter in the virtual image than other elements in the virtual image, such as the lane marking and the turn-by-turn (TBT) navigation information, as shown in FIG. 2b.

FIG. 2c illustrates yet another example virtual image that may be produced by head up display arrangement 10. In response to camera 9 and processor 13 determining that driver 28 is looking at turn-by-turn (TBT) navigation information, processor 13 may cause the turn-by-turn (TBT) navigation information to be brighter in the virtual image than other elements in the virtual image, such as the lane marking and the vehicle speed indication, as shown in FIG. 2c.

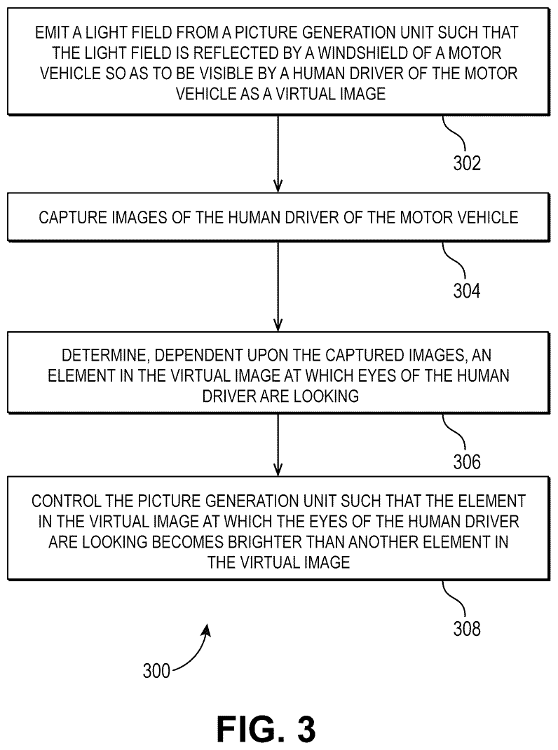

FIG. 3 illustrates one embodiment of a method 300 of the present invention for operating a head up display in a motor vehicle. In a first step 302, a light field is emitted from a picture generation unit such that the light field is reflected by a windshield of the motor vehicle so as to be visible by a human driver of the motor vehicle as a virtual image. For example, light field 20 emitted from PGU 12 may be reflected by windshield 26 such that light field 20 is visible to driver 28 as a virtual image 30.

Next, in step 304, images of a human driver of the motor vehicle are captured. For example, driver-monitoring camera 9 may capture images of the face of a human driver 28.

In a next step 306, an element in the virtual image at which eyes of the human driver are looking is determined dependent upon the captured images. For example, electronic processor 13 receives the images captured by camera 9 and analyzes the images to determine the direction in which the eyes of driver 28 are looking. Based on the direction in which processor 13 determines that driver 28 is looking, processor 13 may also ascertain what elements in virtual image 30 driver 28 is looking at.

In a final step 308, the picture generation unit is controlled such that the element in the virtual image at which the eyes of the human driver are looking becomes brighter than another element in the virtual image. For example, Processor 13 may adjust light field 20 as emitted by PGU 12 to make the element at which driver 28 is looking brighter than the elements at which driver 28 is not looking.

The invention has been described herein as increasing the brightness of an element in the virtual image that the driver is looking at. However, other characteristics of the element that is being looked at may be changed within the scope of the invention. In one embodiment, the size of the element in the virtual image that the driver is looking at is increased. In another embodiment, the color of the element in the virtual image that the driver is looking at is changed. It is also within the scope of the invention to perform any combination of increasing the brightness; increasing the size; and changing the color of the element in the virtual image that the driver is looking at.

The invention has been described above as being applied to a head up display that reflects a light field by use of mirrors. However, it is to be understood that the invention also applies to a head up display that does not use mirrors.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle, the arrangement comprising:
a driver-monitoring camera configured to capture images of a human driver of the motor vehicle;
a picture generation unit configured to emit a light field such that the light field is reflected by a windshield of the motor vehicle so as to be visible by a human driver of the motor vehicle as a virtual image; and
an electronic processor communicatively coupled to the driver-monitoring camera and to the picture generation unit, the electronic processor being configured to:
receive the images captured by the driver-monitoring camera;
determine, dependent upon the captured images, an element in the virtual image at which eyes of the human driver are looking; and
control the picture generation unit to increase a relative brightness of the element in the virtual image at which eyes of the human driver are looking as compared to a brightness of another element in the virtual image.

2. The head up display arrangement of claim 1 wherein the electronic processor is configured to increase a relative brightness of the element in the virtual image at which eyes of the human driver are looking by performing local dimming.

3. The head up display arrangement of claim 1 wherein the electronic processor is configured to increase a relative brightness of the element in the virtual image at which eyes of the human driver are looking by increasing a brightness of the element in the virtual image at which eyes of the human driver are looking.

4. The head up display arrangement of claim 1 wherein the electronic processor is configured to increase a relative brightness of the element in the virtual image at which eyes of the human driver are looking by decreasing a brightness of an element in the virtual image at which eyes of the human driver are not looking.

5. The head up display arrangement of claim 1 wherein the electronic processor is configured to perform eye-tracking on the images captured by the driver-monitoring camera.

6. The head up display arrangement of claim 1 wherein the electronic processor is configured to increase a relative size of the element in the virtual image at which eyes of the human driver are looking as compared to a size of another element in the virtual image.

7. The head up display arrangement of claim 1 wherein the electronic processor is configured to change a color of the element in the virtual image at which eyes of the human driver are looking.

8. The head up display arrangement of claim 1 wherein the electronic processor is configured to change a color of an element in the virtual image at which eyes of the human driver are not looking.

9. A method of operating a head up display in a motor vehicle, the method comprising:
emitting a light field from a picture generation unit such that the light field is reflected by a windshield of the motor vehicle so as to be visible by a human driver of the motor vehicle as a virtual image;
capturing images of the human driver of the motor vehicle;
determining, dependent upon the captured images, an element in the virtual image at which eyes of the human driver are looking; and
controlling the picture generation unit such that the element in the virtual image at which the eyes of the human driver are looking becomes brighter than another element in the virtual image.

10. The method of claim 9 wherein the controlling step includes performing local dimming.

11. The method of claim 9 wherein the controlling step includes increasing a brightness of the element in the virtual image at which eyes of the human driver are looking.

12. The method of claim 9 wherein the controlling step includes decreasing a brightness of an element in the virtual image at which eyes of the human driver are not looking.

13. The method of claim 9 wherein the determining step includes performing eye-tracking on the images captured by the driver-monitoring camera.

14. The method of claim 9 further comprising increasing a relative size of the element in the virtual image at which eyes of the human driver are looking as compared to a size of another element in the virtual image.

15. The method of claim 9 further comprising changing a color of the element in the virtual image at which eyes of the human driver are looking.

16. The method of claim 9 further comprising changing a color of an element in the virtual image at which eyes of the human driver are not looking.

17. A head up display arrangement for a motor vehicle, the arrangement comprising:
a driver-monitoring camera configured to capture images of a human driver of the motor vehicle;
a picture generation unit configured to emit a light field such that the light field is reflected by a windshield of the motor vehicle so as to be visible by a human driver of the motor vehicle as a virtual image; and
an electronic processor communicatively coupled to the driver-monitoring camera and to the picture generation unit, the electronic processor being configured to:
receive the images captured by the driver-monitoring camera;
determine, dependent upon the captured images, an element in the virtual image at which eyes of the human driver are looking; and
control the picture generation unit to change a characteristic of the element in the virtual image at which eyes of the human driver are looking.

18. The head up display arrangement of claim 17 wherein the electronic processor is configured to increase a relative brightness of the element in the virtual image at which eyes of the human driver are looking, the brightness of the element in the virtual image at which eyes of the human driver are looking being increased relative to a remainder of the virtual image.

19. The head up display arrangement of claim 17 wherein the electronic processor is configured to increase a relative brightness of the element in the virtual image at which eyes of the human driver are looking by increasing an absolute brightness of the element in the virtual image at which eyes of the human driver are looking.

20. The head up display arrangement of claim 17 wherein the electronic processor is configured to increase a relative brightness of the element in the virtual image at which eyes of the human driver are looking by decreasing an absolute brightness of an element in the virtual image at which eyes of the human driver are not looking.
